(19) United States
(12) Patent Application Publication
(10) Pub. No.: US 2003/0104251 A1
(43) Pub. Date: Jun. 5, 2003

(54) Magnetic recording medium and manufacture method therefore and magnetic recording apparatus

(75) Inventors: Takahiro Shimizu, Nagano (JP); Hiroyuki Uwazumi, Nagano (JP); Naoki Takizawa, Nagano (JP); Tadaaki Oikawa, Nagano (JP); Miyabi Nakamura, Nagano (JP)

Correspondence Address: STAAS & HALSEY LLP, 700 11TH STREET, NW, SUITE 500, WASHINGTON, DC, 20001, US

(73) Assignee: Fuji Electric Co., Ltd, Kawasaki (JP)

(21) Appl. No.: 10/273,351

(22) Filed: Oct. 18, 2002

(30) Foreign Application Priority Data
Oct. 18, 2001 (JP) 2001-320798

(51) Int. Cl. G11B 5/66

(52) U.S. Cl. 428/694 MM; 428/694 IS; 428/694 EC; 428/694 ST; 428/694 R

(57) ABSTRACT

A magnetic recording medium and manufacture method therefore and magnetic recording apparatus include a nonmagnetic base layer, a nonmagnetic intermediate layer, and a magnetic layer. The nonmagnetic base layer, the nonmagnetic intermediate layer, and the magnetic layer are sequentially stacked on a nonmagnetic substrate to control a partial pressure of H₂O in an Ar atmosphere during film formation to make crystal grains of the magnetic layer finer, to obtain a uniform grain size, and to exhibit ferromagnetism and a nonmagnetic grain boundary surrounding the fine crystal grains.

### CROSS-REFERENCE TO RELATED APPLICATIONS

This application claims the benefit of Japanese Application No. 2001-320798, filed Oct. 18, 2001 in the Japanese Patent Office, the disclosure of which is incorporated herein by reference.

### BACKGROUND OF THE INVENTION

1. Field of the Invention

The present invention relates to a magnetic recording medium that is applicable to a vertical magnetic recording medium or the like mounted on various magnetic recording apparatuses including external storage devices for computers, as well as a manufacturing method of the magnetic recording medium, and a magnetic recording apparatus.

2. Description of the Related Art

For magnetic recording media having an increased density and reduced noise, various compositions and structures of a magnetic layer, materials for a nonmagnetic base layer, and the like have been proposed. In particular, in recent years, the magnetic layer commonly referred to as a “granular magnetic layer” has been proposed in which a nonmagnetic nonmetallic substance, such as an oxide or nitride, surrounds a periphery of magnetic crystal grains.

For example, Japanese Patent Application Laid Open Publication No. 8-255342 proposes that noise be reduced by sequentially stacking a nonmagnetic film, a ferromagnetic film, and a nonmagnetic film, and then heating the stack to form the granular recording layer in which ferromagnetic crystal grains are dispersed in the nonmagnetic film. In this case, the nonmagnetic film includes of a silicon oxide, a silicon nitride, or the like.

Further, U.S. Pat. No. 5,679,473 describes a method of using a CoNiPt target doped with an oxide such as SiO₂ to carry out an RF sputtering in order to form a granular recording film in which the magnetic crystal grains are separated from one another and surrounded by a nonmagnetic oxide, thereby achieving a high-coercive-force Hc and reduced noise.

A reason the granular magnetic film features reduced noise characteristics has been assumed to be because a nonmagnetic, nonmetallic grain-boundary phase physically separates magnetic grains from one another to weaken magnetic crystal interaction among the magnetic grains, thereby hindering zigzag magnetic domain walls from being formed in recording-bit transition regions.

A conventional CoCr-based metallic magnetic film is formed at high temperatures, so that Cr is segregated from Co-based magnetic grains and deposited at a grain boundary to weaken the magnetic interaction among the magnetic grains. However, in the granular magnetic layer, the grain-boundary phase is a nonmagnetic, nonmetallic substance which is more likely to be deposited than the Cr in the prior art, thereby advantageously allowing the magnetic grains to be isolated relatively easily.

In particular, for the conventional CoCr-based metallic magnetic films, it is essential to increase a temperature of a substrate to 200° C. or higher during film formation in order to sufficiently deposit the Cr. In contrast, for the granular magnetic layer, even if a film is formed without heating, the nonmagnetic, nonmetallic substance is deposited to provide excellent magnetic characteristics and electromagnetic conversion characteristics.

However, the granular magnetic layer includes crystal grains having a metallic ferromagnetic material and a crystal grain-boundary layer of a nonmagnetic, nonmetallic material such as an oxide or nitride. If the magnetic layer is formed by the sputtering process, the magnetic characteristics and electromagnetic conversion characteristics are substantially determined by a compounding ratio of the magnetic material and the oxide or the nitride, and a room pressure during film formation.

### SUMMARY OF THE INVENTION

It is thus an aspect of the present invention to adjust the partial pressure of H₂O in an Ar gas atmosphere when a magnetic film is formed, in order to provide a magnetic recording medium having excellent electromagnetic conversion characteristics such as reduced noise. A manufacturing method of the magnetic recording medium, and a magnetic recording apparatus are also provided.

In accordance with an embodiment of the present invention, there is provided a magnetic recording medium including at least a nonmagnetic base layer, a nonmagnetic intermediate layer, and a magnetic layer sequentially stacked on a nonmagnetic substrate. A partial pressure of H₂O in an Ar atmosphere is controlled during film formation to make crystal grains constituting the magnetic layer finer to obtain a uniform grain size, so that the magnetic layer includes fine crystal grains having a uniform grain size and exhibits ferromagnetism. A nonmagnetic grain boundary surrounds the fine crystal grains, and is formed so as to have excellent electromagnetic conversion characteristics including reduced noise.

In this case, the nonmagnetic base layer may include W, Mo, and V, or W, Mo, and Cr, or a V alloy containing 10 at % or more and 50 at % or less of Ti. The nonmagnetic intermediate layer may include Ru, Ir, Rh, and Re, or Ru, Ir, and Rh, or an Re alloy containing 10 at % or more and 50 at % or less of Ti, C, W, Mo, or Cu. The nonmagnetic substrate may be a crystallized glass, a chemically reinforced glass, or a plastic.

In accordance with an embodiment of the present invention, there is provided a method of manufacturing a magnetic recording medium by sequentially stacking a nonmagnetic base layer, a nonmagnetic intermediate layer, and a magnetic layer on a nonmagnetic substrate, wherein a partial pressure of H₂O in an Ar atmosphere is controlled during film formation to make crystal grains of the magnetic layer finer, in order to obtain a uniform grain size, so that the magnetic layer includes the fine crystal grains having the uniform grain size and exhibits ferromagnetism and a nonmagnetic grain boundary surrounding the fine crystal grains, and is formed so as to have excellent electromagnetic conversion characteristics including reduced noise.

In this case, the partial pressure of H₂O during film formation may be controlled to an order of 10⁻⁹ Torr, and, for instance, to within the range from 2×10⁻⁸ Torr to 2×10⁻⁹ Torr. A film formation process may be executed without heating the nonmagnetic substrate in advance. In accordance with an embodiment of the present invention, there is provided a magnetic recording apparatus including the above-described magnetic recording medium mounted therein.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

These and other aspects and advantages of the invention will become apparent and more readily appreciated from the following description of the embodiments, taken in conjunction with the accompanying drawings of which:

FIG. 1 is a sectional view showing a structure of a magnetic recording medium according to an embodiment of the present invention.

FIG. 2 is a block diagram showing an example of a configuration of a sputtering apparatus used to manufacture the magnetic recording medium.

FIG. 3 is a characteristic diagram showing noise characteristics, an electromagnetic conversion characteristic of the magnetic recording medium, and more specifically a variation of noise vs. linear density.

FIG. 4 is a characteristic diagram showing SNR characteristics, an electromagnetic conversion characteristic of the magnetic recording medium, and more specifically a variation of SNR vs. the linear density.

FIG. 5 is a diagram illustrating the noise and the SNR according to an embodiment of the present invention compared with the noise and the SNR according to a conventional example.

FIG. 6 is a characteristic diagram showing an area ratio vs. a crystal grain size.

FIG. 7 is a diagram illustrating comparisons of an average grain size and standard deviation according to an embodiment of the present invention with those according to a conventional example.

FIG. 8 is a perspective view showing an example of a configuration of a magnetic disk drive in which the magnetic recording medium is accommodated.

### DETAILED DESCRIPTION OF THE PREFERRED EMBODIMENTS

Hereinafter, embodiments of the present invention will be described in detail with reference to the attached drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

First, a structure of a magnetic recording medium according to an embodiment of the present invention will be described.

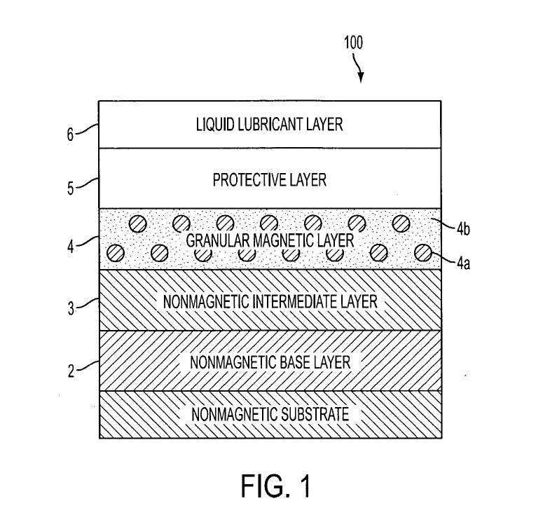

FIG. 1 shows a cross section of a magnetic recording medium 100. The magnetic recording medium 100 includes a nonmagnetic base layer 2, a nonmagnetic intermediate layer 3, a granular magnetic layer 4, a protective layer 5, and a liquid lubricant layer 6 sequentially stacked on a nonmagnetic substrate 1. The nonmagnetic substrate 1 includes a crystallized glass, a chemically reinforced glass, or a plastic. The nonmagnetic base layer 2 includes W, Mo, and V, or W, Mo, and Cr, or a V alloy containing 10 at % or more and 50 at % or less of Ti. The nonmagnetic intermediate layer 3 includes Ru, Ir, Rh, and Re, or Ru, Ir, and Rh, or an Re alloy containing 10 at % or more and 50 at % or less of Ti, C, W, Mo, or Cu.

The granular magnetic layer 4 includes fine crystal grains 4a exhibiting ferromagnetism and a nonmagnetic grain boundary 4b surrounding the fine crystal grains 4a. The fine crystal grains 4a exhibiting ferromagnetism may be composed primarily of, for example, Co (cobalt).

In this case, a partial pressure of H₂O in an Ar atmosphere is controlled during film formation to further reduce a grain size of the fine crystal grains 4a in order to obtain uniform crystal grains. When the processed fine crystal grains 4a have a uniform grain size and exhibit ferromagnetism, electromagnetic characteristics such as noise characteristics and SNR characteristics can be improved.

Next, a manufacturing method for the magnetic recording medium 100 will be described.

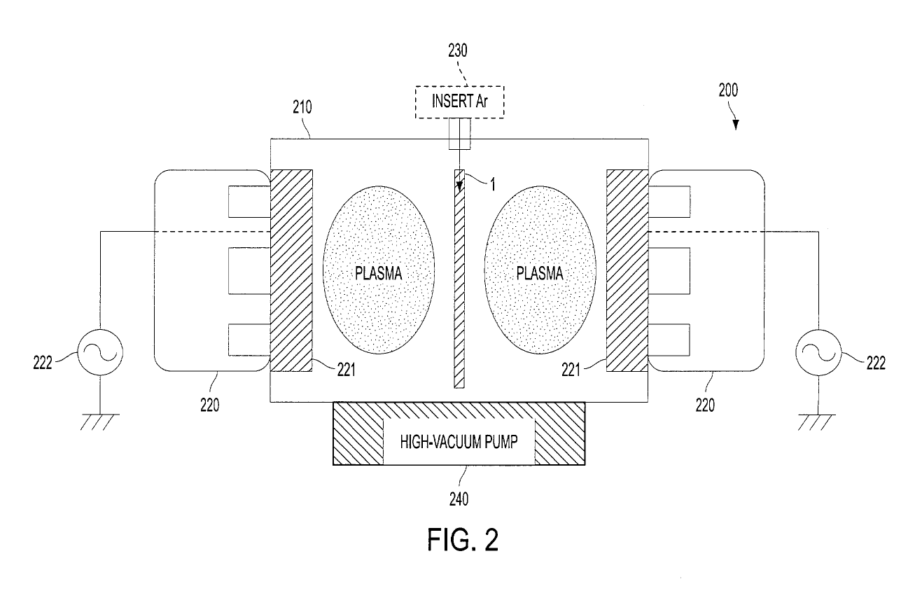

FIG. 2 shows an example of a configuration of a sputtering apparatus 200 used to manufacture the magnetic recording medium 100. The sputtering apparatus 200 includes a chamber 210 in which a film is formed, electrode sections 220 arranged at lateral opposite ends of the chamber 210 to generate high-frequency fields (RF), an inlet 230 provided at a top of the chamber 210 and through which an Ar gas flows into the sputtering apparatus 200, and a high-vacuum pump 240 provided at a bottom of the chamber 210. The electrode sections 220 are each composed of an RF cathode electrode 221 and an RF power supply 222 used to generate plasma in the chamber 210.

To manufacture a magnetic recording medium, a crystallized glass substrate with smooth surfaces is first provided as the nonmagnetic substrate 1. The nonmagnetic substrate 1 is not heated. Heating is omitted because, according to an embodiment of the present invention, the present invention provides, even without heating, characteristics similar to those obtained when the nonmagnetic substrate 1 is heated with a conventional Al or glass medium. It is a precondition that a crystal is commonly deposited by heating, and for a granular film, the deposition is facilitated using a matrix of an oxide or the like.

Then, the nonmagnetic substrate 1 is washed and introduced into the sputtering apparatus 200. At an Ar gas pressure of 15 mTorr, a nonmagnetic base layer 2 including Ti 50 at % W is formed on the nonmagnetic substrate 1 to a thickness of 10 nm. Then, at the Ar gas pressure of 15 mTorr, a nonmagnetic intermediate layer 3 including Ru is formed on the nonmagnetic base layer 2 to a thickness of 10 nm. Then, at the Ar gas pressure of 15 mTorr, a CoCr₁₀Pt₁₄ target doped with 7 mol % SiO₂ is used to form the granular magnetic layer 4 on the nonmagnetic intermediate layer 3 to a thickness of 15 nm. During the film formation, the partial pressure of H₂O in the Ar atmosphere is controlled. In this case, during the film formation, the partial pressure of H₂O is controlled to the order of 10⁻⁹ Torr. For instance, the partial pressure of H₂O is controlled to within a range from 2×10⁻⁸ Torr to 2×10⁻⁹ Torr.

The control of the partial pressure of H₂O will be described.

The term “partial pressure” as used herein indicates a pressure of a particular component in a mixed gas. Ar molecules do not account for one hundred percent of the high-vacuum Ar atmosphere, but various molecules are present in the Ar atmosphere. In this example, in the Ar atmosphere during film formation, the partial pressure of H₂O is 10⁻⁹ Torr or higher (i.e. 10⁻⁸ Torr, 10⁻⁷ Torr, . . . ). By way of example, when the atmosphere contains 20% oxygen (O₂) and 80% nitrogen (N₂) (under a condition that no other gases are present) at 1 atm, i.e., 760 Torr, a partial pressure of O₂ is 152 Torr and a partial pressure of N₂ is 608 Torr.

The protective layer 5 including a carbon film is then stacked on the granular magnetic layer 4 to a thickness of 10 nm. The stack is then removed from the vacuum in the chamber 210. Subsequently, the liquid lubricant layer 6 is applied on the protective layer 5 to a thickness of 1.5 nm. In this manner, the magnetic recording medium 100 constructed as shown in FIG. 1 is produced.

Next, electromagnetic conversion characteristics of the produced magnetic recording medium 100 will be described.

1. Noise and SNR Characteristics

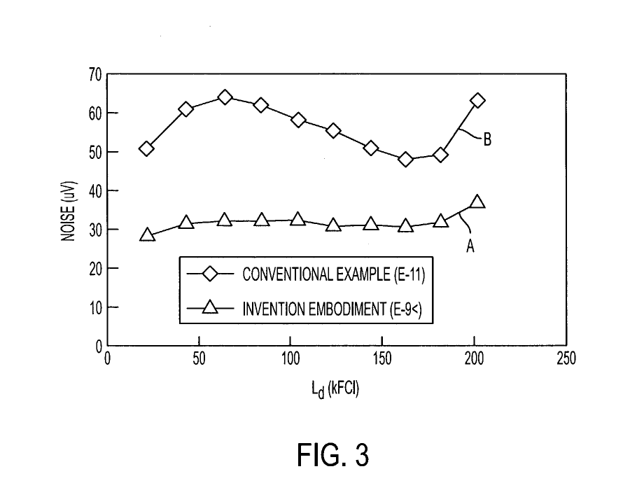

FIG. 3 shows results of measurements of noise characteristics, one of the electromagnetic conversion characteristics of the magnetic recording medium 100. FIG. 3 shows the noise characteristics vs. linear density Ld measured using a spin stand tester with a GMR head (magnetic-resistance head). Curve A denotes the noise produced in the magnetic recording medium 100 according to an embodiment of the present invention, so that the partial pressure of H₂O during film formation is 10⁻⁹ Torr. Curve B denotes noise that occurs in a conventional magnetic recording medium.

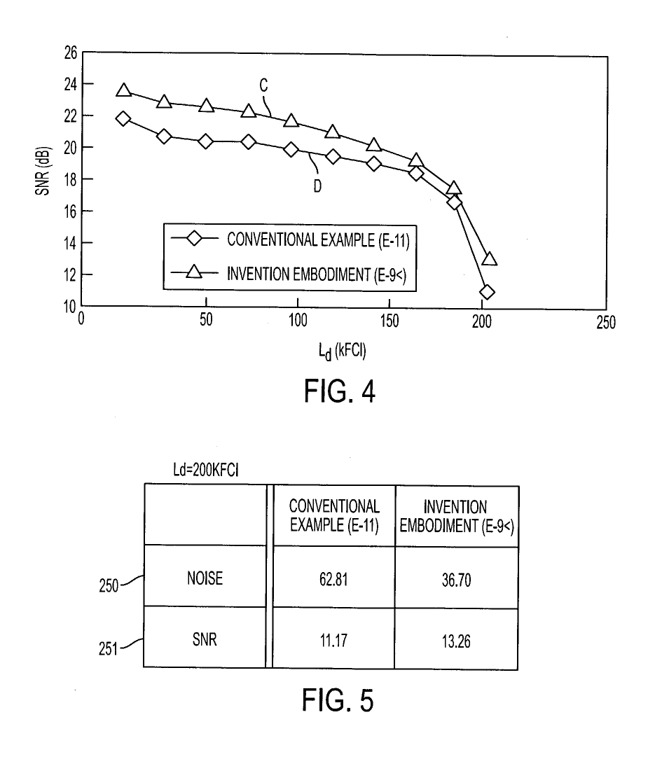

FIG. 4 shows the results of measurements of SNR characteristics, one of the electromagnetic conversion characteristics of the magnetic recording medium 100. FIG. 4 shows a signal to noise ratio (SNR) vs. the linear density Ld. Curve C denotes the SNR of the magnetic recording medium 100, according to an embodiment of the present invention, produced so that the partial pressure of H₂O during film formation is 10⁻⁹ Torr. Curve D denotes the SNR of the conventional magnetic recording medium. In this case, the measured samples are assumed to provide equivalent reproduction outputs.

FIG. 5 shows results of comparisons of a noise 250 and an SNR 251 according to an embodiment of the present invention with those according to the conventional magnetic recording medium. All values are obtained through measurements at the linear density Ld of approximately 200 KFCI. The noise 250 is 36.70 according to an embodiment of the present invention, whereas the noise 250 is 62.81 according to the conventional magnetic recording medium. Therefore, according to an exemplary embodiment, the present invention enables the noise to be reduced by approximately 50%.

The SNR 251 is 13.26 according to an embodiment of the present invention, whereas the SNR 251 is 11.17 according to the conventional magnetic recording medium. Therefore, according to an exemplary embodiment, the present invention enables the SNR to be reduced by approximately 5%.

Here, the linear density Ld will be described. In general, FCI (Flux Changes per Inch)×TPI (Tracks per Inch)=Bits/in² (surface recording density) where at present, the standard value is approximately 50 KTPI. The TPI depends on specifications of a HDD (Hard Disk Drive). HD (Hard Disk) manufacturers evaluate tested characteristics of the FCI in order to determine to what Bits/in² the HD is equivalent. However, it is assumed, for exemplary purposes, that a value of approximately 200 KFCI is the limit of measurements using a spin stand, which relates to a write head and a compatibility of a frequency of a tester. Thus, in embodiments of the present invention, the linear density Ld is measured at a position at which a radius R of the magnetic recording medium 100 is 35 mm, with a rotation speed N set at 5400 rpm. Then, the noise and SNR values measured at a linear density of 200 KFCI are compared.

2. Comparison of Crystal Grains

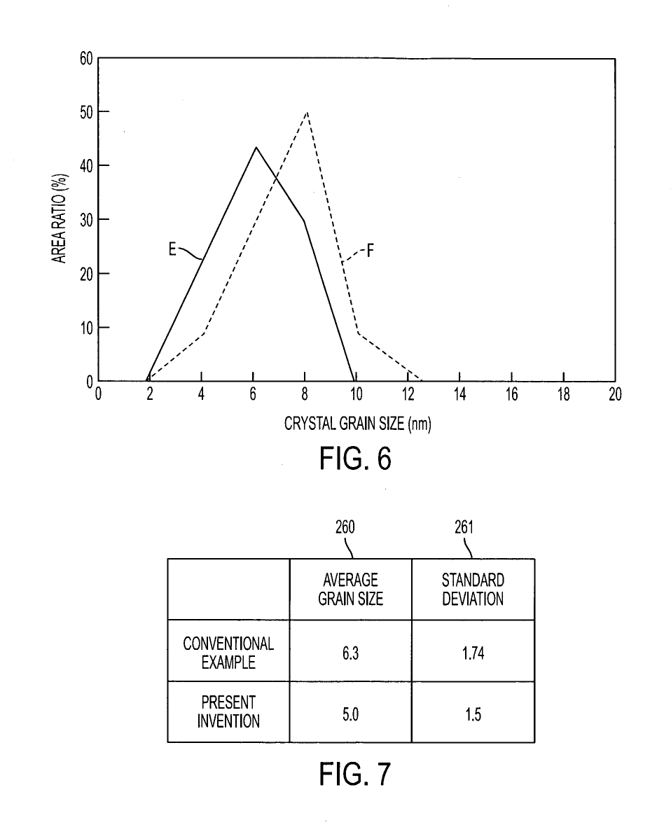

FIG. 6 shows an area ratio vs. a crystal grain size. The crystal grain size is measured using a TEM (transmission electronic microscope). For example, a surface ratio of 40% on curve E means that approximately 40% of all crystal grains have crystal grain sizes of 5.5 nm or 7 nm.

Curve E denotes a distribution of crystal grain sizes in the magnetic recording medium 100 of an embodiment of the present invention, produced so that the partial pressure of H₂O during film formation is 10⁻⁹ Torr. Curve F denotes a distribution of crystal grain sizes in the conventional magnetic recording medium.

FIG. 7 shows an average grain size 260 and a standard deviation 261 according to an embodiment of the present invention determined from curves E and F of FIG. 6, and compared with those according to the conventional example. The average grain size 260 is 6.3, according to the conventional magnetic recording medium, and 5.0, according to an embodiment of the present invention. The standard deviation 261 is 1.74, according to the conventional magnetic recording medium, and 1.5, according to an embodiment of the present invention.

The results of the experiments indicate that the crystal grains, according to an embodiment of the present invention have a smaller grain size and a smaller variation in size than the crystal grains according to the prior art, which indicates that the present invention serves to make the crystal grains finer and more uniform. The results of the experiments indicate that by controlling the partial pressure of H₂O in the Ar atmosphere during the film formation, the crystal grains constituting the granular magnetic layer 4 can be made finer and more uniform, thereby improving electromagnetic conversion characteristics such as the noise and the SNR characteristics.

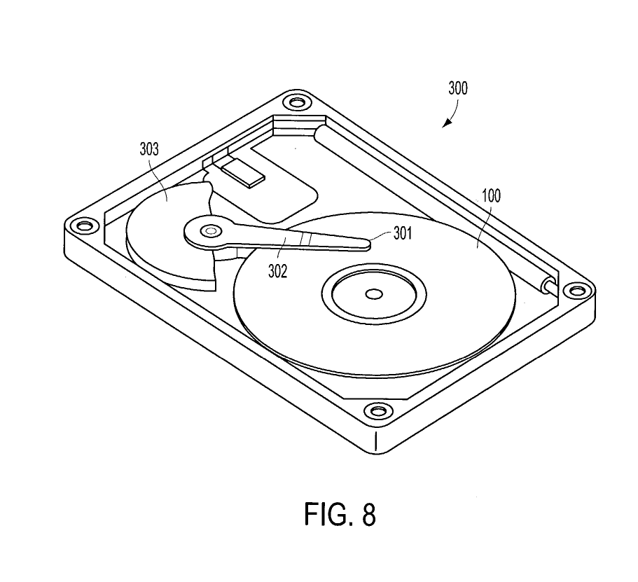

FIG. 8 shows an example of the configuration of a magnetic disk drive 300 in which a magnetic recording medium 100 produced by controlling the partial pressure of H₂O in the Ar atmosphere is accommodated. A GMR head 301 supported by an arm 302 is arranged near and opposite to the magnetic recording medium 100. The GMR head 301 is rotationally moved by a voice coil motor 303 used to drive the head.

As described above, in accordance with an embodiment of the present invention, there is provided a magnetic recording medium including at least a nonmagnetic base layer, a nonmagnetic intermediate layer, and a magnetic layer sequentially stacked on a nonmagnetic substrate. A partial pressure of H₂O in an Ar atmosphere is controlled during film formation to make crystal grains constituting the magnetic layer finer, in order to obtain a uniform grain size, so that the magnetic layer is made of fine crystal grains having a uniform grain size and exhibiting ferromagnetism and a nonmagnetic grain boundary surrounding the fine crystal grains. Therefore, a magnetic recording medium can be produced having excellent electromagnetic conversion characteristics such as reduced noise and an increased SNR.

The various features and advantages of the invention are apparent from the detailed specification and, thus, it is intended by the appended claims to cover such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A magnetic recording medium, comprising:
a nonmagnetic base layer,
a nonmagnetic intermediate layer, and
a magnetic layer, wherein the nonmagnetic base layer, the nonmagnetic intermediate layer, and the magnetic layer are sequentially stacked on a nonmagnetic substrate to control a partial pressure of H₂O in an Ar atmosphere during film formation to make crystal grains of the magnetic layer finer, to obtain a uniform grain size, and to exhibit ferromagnetism and a nonmagnetic grain boundary surrounding the fine crystal grains.

2. The magnetic recording medium according to claim 1, wherein the nonmagnetic base layer comprises W, Mo, and V, or W, Mo, and Cr, or a V alloy containing 10 at % or more and 50 at % or less of Ti.

3. The magnetic recording medium according to claim 1, wherein the nonmagnetic intermediate layer comprises Ru, Ir, Rh, and Re, or Ru, Ir, and Rh, or an Re alloy containing 10 at % or more and 50 at % or less of Ti, C, W, Mo, or Cu.

4. The magnetic recording medium according to claim 2, wherein the nonmagnetic intermediate layer comprises Ru, Ir, Rh, and Re, or Ru, Ir, and Rh, or an Re alloy containing 10 at % or more and 50 at % or less of Ti, C, W, Mo, or Cu.

5. The magnetic recording medium according to claim 1, wherein the nonmagnetic substrate is a crystallized glass, a chemically reinforced glass, or a plastic.

6. The magnetic recording medium according to claim 2, wherein the nonmagnetic substrate is a crystallized glass, a chemically reinforced glass, or a plastic.

7. The magnetic recording medium according to claim 3, wherein the nonmagnetic substrate is a crystallized glass, a chemically reinforced glass, or a plastic.

8. A method of manufacturing a magnetic recording medium by sequentially stacking a nonmagnetic base layer, a nonmagnetic intermediate layer, and a magnetic layer on a nonmagnetic substrate, the method comprising:
controlling a partial pressure of H₂O in an Ar atmosphere during film formation to make the crystal grains of the magnetic layer finer, to obtain a uniform grain size, and to exhibit ferromagnetism and a nonmagnetic grain boundary surrounding the fine crystal grains.

9. The method of manufacturing a magnetic recording medium according to claim 8, wherein a partial pressure of H₂O during film formation is controlled to the order of 10⁻⁹ Torr.

10. The method of manufacturing a magnetic recording medium according to claim 8, wherein a partial pressure of H₂O during film formation is controlled to within the range from 2×10⁻⁸ Torr to 2×10⁻⁹ Torr.

11. The method of manufacturing a magnetic recording medium according to claim 8, wherein a film formation process is executed without heating the nonmagnetic substrate in advance.

12. The method of manufacturing a magnetic recording medium according to claim 10, wherein a film formation process is executed without heating the nonmagnetic substrate in advance.

13. A magnetic recording apparatus of a magnetic recording medium, the magnetic recording medium comprising:
a nonmagnetic base layer;
a nonmagnetic intermediate layer; and
a magnetic layer, wherein the nonmagnetic base layer, the nonmagnetic intermediate layer, and the magnetic layer are sequentially stacked on a nonmagnetic substrate to control a partial pressure of H₂O in an Ar atmosphere during film formation to make crystal grains of the magnetic layer finer, to obtain a uniform grain size, and to exhibit ferromagnetism and a nonmagnetic grain boundary surrounding the fine crystal grains.

14. The magnetic recording apparatus according to claim 13, wherein the nonmagnetic base layer comprises W, Mo, and V, or W, Mo, and Cr, or a V alloy containing 10 at % or more and 50 at % or less of Ti.

15. The magnetic recording apparatus according to claim 13, wherein the nonmagnetic intermediate layer comprises Ru, Ir, Rh, and Re, or Ru, Ir, and Rh, or an Re alloy containing 10 at % or more and 50 at % or less of Ti, C, W, Mo, or Cu.

16. The magnetic recording apparatus according to claim 13, wherein the nonmagnetic substrate is a crystallized glass, a chemically reinforced glass, or a plastic.
